(19) United States
(12) Patent Application Publication
(10) Pub. No.: US 2014/0193582 A1
(43) Pub. Date: Jul. 10, 2014

(54) Method for treating a hollow glass article comprising a coating and a facility for implementing the method

(71) Applicant: Loïc Quentin De Gromard, Colombes (FR)

(72) Inventor: Loïc Quentin De Gromard, Colombes (FR)

(73) Assignee: SAVERGLASS, FEUQUIERES (FR)

(21) Appl. No.: 14/235,117

(22) PCT Filed: Jul. 29, 2011
(86) PCT No.: PCT/FR2011/000451

§ 371 Date: Feb. 5, 2014

(51) Int. Cl. C03C 17/00; C03C 19/00; B24C 11/00; B24C 3/32; B24C 9/00; C03C 23/00; B44C 1/22

(52) U.S. Cl. CPC C03C 17/003; C03C 23/0075; C03C 19/00; B44C 1/221; B24C 3/32; B24C 9/006; B24C 11/00
USPC 427/289; 134/7; 451/38; 451/39; 451/88

(57) ABSTRACT

According to a method for treating a hollow glass article (2) comprising a coating (21), a flow (F) of abrasive material (A) in the form of organic solid particles is projected against the article (2) to at least partially remove the coating (21). Facility for implementing the method.

### TECHNICAL FIELD

The invention concerns a method for treating a hollow glass article having a coating. It also concerns a method for decorating a said article and a facility for implementing the treatment method.

### BACKGROUND

The fields concerned by the food industry and cosmetics industry have long been users of hollow glass items such as bottles in particular to contain liquids such as beverages whether or not alcoholic, lotions, creams or perfumes. The term bottle herein is a generic designation of glass containers such as jars, cups, jugs and bottles. Prints are frequently applied onto such items to provide information and decorative patterns. Coatings are also applied to large surface areas to impart special functional properties or to modify the eye-appealing appearance. With regard to prints, serigraphy or transfer techniques are typically used such as decalcomania or tamp print. For extensive coatings a material is deposited in a thin film by spraying. In both cases, the coatings are composed of inks, paints or varnishes for example containing organic resins. The resins are polymerized once applied to the bottle, for example by exposure to heat or ultraviolet radiation or after physical drying. Some resins are sensitive both to heat and to ultraviolet radiation. The resins may be of epoxy, acrylic or polyurethane type.

The coatings may also be non-organic e.g. enamel. Said coating is applied in the form of a paste containing the minerals in frit form together with an organic binder. When placed in a furnace the binder is calcined and the minerals bind and form the enamel on the surface of the article.

Other coatings are essentially metallic. For example a composition is used containing organometallic pastes with metals in cationic forms. The composition is deposited on the surface of the article and the cations are reduced and take on a metal form. This method is particularly applied to gold, silver or alloys of these metals or of other metals. Document U.S. Pat. No. 2,490,399 gives an example of said technique.

These coatings are applied to the article by serigraphy for example. This provides the opportunity for localized application and for extensively fine patterns. However, the application of this technique is limited to developable surfaces. It is not unusual to have bottles of complex shape which do not allow the application of said technique. The decalcomania technique also has the same limitations.

Among the decorative effects that are obtained is the satin-finish appearance of the outer surface of the bottle, also called frosted finish. Historically this appearance is obtained by treating the surface with chemical attack using a solution containing acid and salts in particular, such as hydrofluoric acid and ammonium salts. In general, the entirety of the outer surface of the bottle is frosted using this method. This method raises major safety and environmental problems including in particular the use of large amounts of water and the fact that the waste is difficult to eliminate.

It is possible to create patterns with partial frosting by applying a varnish which forms a mask on the regions not to be attacked and are to remain smooth. In this manner types of windows are formed through which the inside of the bottle remains visible whilst the remainder of the surface is made translucent. The varnish is then removed e.g. via chemical attack with sodium hydroxide or via mechanical route using pressurized water jets. The windows thereby resume their original glass transparency. However, the application of the varnish is subject to its limitation to developable surfaces as previously indicated. It has also been endeavored to impart a smooth transparent appearance to frosted portions by applying a colorless varnish thereto to fill in the roughness of chemical frosting. The results obtained are scarcely satisfactory with regard to the quality of transparency obtained.

An alternative solution for obtaining a frosted appearance was proposed for example in document WO 2008/155576 A1 in which the application was described of a particular varnish to the surface of the bottle, this varnish imparting a frosted appearance to the glass article.

In addition, for the application of a lacquer or varnish by spraying the article, it is sometimes desirable only to obtain the synthetic coating on some portions of the article. For this purpose, different techniques have been proposed.

For example a technique is known whereby a flexible adhesive mask is applied to the article before applying the coating. This mask is removed after application of the coating which leaves intact the surface of the article which had been protected by the mask. However, the mask must be able to withstand surrounding constraints during the polymerization operation of the coating resins e.g. thermal constraints for heat polymerization. In addition, the mask removal operation is awkward and essentially manual. The coating is torn and may become detached on the periphery of the mask when it is removed, which gives a jagged appearance to the separation. Finally, the technique is limited to developable surfaces having regard to the constraints of applying the mask and is not suitable for fine decorations such as wording which require a multiple-fold increase in the number of masks to be deposited and removed and are difficult to access.

Use has also been made of a technique for depositing resin by spraying through a mask having openings and placed in front of the article. The resin is therefore only deposited on the points facing the openings. The quality of the coating is difficult to control. It is effectively important that the space between the mask and the article should be very narrow so as not to allow lacquer or varnish to enter in the form of droplets behind the mask. These droplets would end up being deposited on the surface of the article which should remain free of lacquer and varnish, and would therefore form a veil of greater or lesser extent. However, the surface of glass bottles has high geometric dispersion from one article to another. If reference is made to manufacturing standards for glass bottles, tolerances of ±1.4 mm in diameter can be found for example. On this account if the position of the mask is fixed, the space between the article and the mask is most variable. It is therefore necessary to be able to adjust this distance for each article, which makes tooling complex. In addition, paint gradually accumulates on the mask which has a tendency to modify the contour of the openings. It is therefore necessary to make provision for frequent cleaning of the mask, which immobilizes the production facility or requires additional sets of masks which can be exchanged in between cleaning operations. This constraint is of importance since this type of cleaning is carried out either under heat by calcining the deposits, which requires a refractory mask, or via chemical route which entails regulatory constraints with regard to environmental aspects.

According to another technique for forming decorative patterns, the coating is locally extracted by sublimation and pyrolysis conducted by exposure to laser radiation e.g. of ultraviolet type. The surface to be freed of the coating is scanned by the laser beam. The implementation time of this method is proportional to the surface to be treated, and uses lasers of limited power which may lead to very long treatment times. In addition, efficacy is dependent on the capacity of the coating to absorb radiation. It cannot therefore be applied to all coatings, and on one same article some parts may not be treated on account of the type of different coating, in particular its pigmentation. If the locating of laser beam focusing is not sufficiently well controlled and if it is focused on the surface of the glass, the method degrades the surface of the article. Such control is far from being obtained for bottles whose dimensional dispersions have already been mentioned. It is also to be noted that sublimation and pyrolysis of the coating generates gaseous compounds which need to be treated.

Additionally, it is to be noted that glass articles are generally given hot surface treatment which consists of depositing a thin layer of tin or titanium oxide on the outer surface of the articles. The purpose of this layer is to provide mechanical reinforcement for the article, in particular resistance to inner pressure for bottles, and to ensure durable adhesion of cold protection treatments.

When production quality controls after application of the decorative patterns discard some articles for pattern effects, such articles are ground and recycled in a glass preparation furnace. This material is used for forming new articles. Even if there is no loss of material, it is necessary to repeat numerous operations some of which use large amounts of energy. The entire added value of the operations previously performed on the articles is lost.

### BRIEF SUMMARY

The invention sets out to provide a method for decorating glass articles with which it is possible to obtain coated and exposed regions with distinct, reproducible delimitation therebetween and which is easy to implement and limits the previously indicated drawbacks. The invention further provides a method for treating glass articles to avoid having to destroy and recycle the articles when the decoration in synthetic coating is not satisfactory.

More specifically, the subject of the invention is a method for treating a hollow glass article having a coating, characterized in that an abrasive flow formed of solid organic particles is sprayed against the article to remove the coating at least in part.

It is found that with this method it is possible to remove an already applied coating and to expose the surface of the glass restoring its original appearance. Most inks or coatings in synthetic material usually used can be selectively or entirely removed without deteriorating the surface of the glass article. For articles to which a layer of titanium or tin oxide has been applied under heat, it is also found that this layer is not affected, thereby preserving the mechanical strength of the article and the physical adhesion properties of future cold surface treatments.

In particular, the abrasive particles are of plant origin. Through their nature these particles are sufficiently hard to attack the coating but sufficiently soft to preserve the surface of the glass article. It is also ascertained that the own geometry of the particles has an influence on the efficacy of the method, in particular through the presence of sharp edges created by fracture of the particles. On account of their origin, the particles are in renewable material and do not use up finite resources. In addition, their elimination does not entail any environmental risk.

The abrasive is formed for example of a material chosen from among a polysaccharide, in particular starch in vitrified form, or crushed nut shells. Tests have shown that these materials allow the expected results to be obtained. In particular, particles of corn starch in vitrified form sold under the name ENVIROSTRIP XL (registered trademark) by ADM have been used to satisfaction. Document EP 396 226 A2 describes these types of particles.

In particular, the coating of the article is organic. This type of coating is less resistant than glass and its possible heat surface treatment, and is well delimited in relation to the substrate. It is therefore possible to remove this coating easily and to expose the glass without leaving any traces of the said coating. For example, the coating is a varnish, a lacquer or ink, in acrylic, polyurethane or epoxy material, with physical drying, polymerized by heat or exposure to ultraviolet radiation, or of mixed polymerization. The coating may have a final shiny, frosted or smooth finish. It may contain components to impart colored, pearl or metal effects by dispersion of particles generally in aluminum. The coating may also have a metallized appearance using thin layer vacuum deposit or spraying of redox solutions as described in document FR 2 934 609 A1. Advantageously, the varnish or lacquer is water-soluble which limits the use and atmospheric discharge of volatile organic compounds. The coating may have been applied in one or more layers of same material, of different materials but of same type or materials of different types, typically in a thickness of the order of 10 to 25 μm per layer. It is found that the removal of the coating is faster the more it is flexible.

According to one embodiment of the method, the glass article contains a coating underlying the first coating and having greater mechanical strength; the first coating is removed at least in part to expose the underlying coating. Since the underlying coating is more resistant, it is not removed by spraying of the abrasive. The underlying coating may be a mineral-based decoration which is generally harder than an organic coating, or it may be a resistant organic coating obtained for example with a composition polymerized by ultraviolet radiation. It may also be a metallic decoration.

In one particular application of the method, the objective of the treatment is the decoration of a glass article, a method whereby a coating is applied to the article, a treatment is performed such as previously described, a mask being inserted between the article and the flow of abrasive so as to preserve the coating behind the mask and remove it elsewhere. In this manner, it is possible to obtain special decorative effects. It is found that with said method it is possible to obtain precise, clean-cut separations between the coated regions and exposed regions. It is therefore possible to delimit regions in precise manner, irrespective of the shape of the surface of the article. These regions are windows for example preserving the transparency of the glass whilst the remainder of the surface is made opaque or translucent by the coating. With a varnish of lacquer of usual thickness no surface discontinuity can be perceived between an exposed region and a region still having the coating, whether visually or to the touch. In different manner, an underlying coating may be visible from behind though the inside of the container. This provides a special effect in which for example a completely different image from the one visible from the outside can be seen inside the container through a window.

Also, since the mask is also cleaned by the abrasive flow which it blocks, no accumulation of material occurs on the mask and the region delimited by the mask is constant and reproducible without it being necessary to make provision for frequent maintenance operations. Productivity is thereby increased and production-specific tooling is reduced. The mask is metallic for example, in steel, aluminum or zamak. It may be rigid and placed a short distance away from the article or flexible so that it can be laid flat against the article following the contour thereof. The lifetime of said mask is very long since the abrasive has practically no effect on the mask and is not subjected to specific cleaning operations.

If the article comprises an underlying coating, this coating becomes apparent at the points where it has been exposed and is masked where the first coating has been left in place. It may be simpler to mask part of the underlying coating rather than to apply the said underlying coating solely at those points where it is to remain visible. The underlying coating may be a metallic coating for example, obtained by baking organometallic pastes. It is therefore easy to combine portions of lacquered decorative patterning and metallic portions. In the prior art, a metallic coating had to be formed before the synthetic coating on account of thermal constraints. This combination was therefore restricted by the difficulty of applying organic coatings limited to certain regions. By means of the invention however a metallic coating can be widely applied and initially covered by the synthetic coating e.g. opaque and later exposed in certain regions by removing the synthetic coating. The metallic coating is then visible solely in those regions where it has been exposed. This technique may also advantageously replace a hot marking technique in which a thin metallic layer is deposited by transfer onto an organic lacquer or varnish. It can also be applied by forming a metallized underlying coating by thin layer deposit as mentioned previously.

According to one particular application of the decorating method, the glass article comprises surfaces that are frosted before the application of a colored coating at least onto part of said surfaces, the coating then being removed at least from part of the frosted surfaces. It is found that the roughness of the parts frosted and treated according to the invention maintain traces of the colored coating which imparts colored reflections to the treated surfaces which can only be seen under certain lighting conditions. Overall, the frosted appearance is maintained but there remains what may be a much faded image.

According to another application of the decorating method, the glass article has a smooth surface and the coating has a frosted appearance. In this manner, a final visual appearance and touch of the article can be obtained that is equivalent to that obtained with chemical frosting restricted to certain regions. The organic coating of frosted appearance is interrupted at certain points and reveals some regions such as they were originally i.e. smooth and transparent. These smooth regions correspond to regions protected against acid attack in the prior art. With the method of the invention it is possible to obtain a similar effect to the prior art whilst dispensing with the use of chemical products hazardous for health and scarcely environmentally friendly. It also allows other effects to be obtained that were previously not accessible. It is possible for example to give coloring to the frosted varnish whilst having a fully transparent window having no color or a different color.

According to another aspect of the invention, the treatment method may also be a method for cleaning a glass article, whereby the article has a coating and the entirety of the coating is removed. It is found that the appearance and surface properties restored to the article are similar to those it had before the coating was applied. A new application of the coating can be carried out directly without any special surface preparation and without any impact on the quality of the coating in terms of appearance, touch or chemical resistance. If defects are found in the application of the coating, it is therefore possible to rework the article and return it to the production line and therefore avoid having to destroy the article. This applies in particular when the article already has an underlying coating such as previously defined.

For the application of the treatment method, the parameter adjustment ranges determined below were found to be satisfactory:
a particle spray nozzle is fed with air at a pressure of between 1.5 and 3.5 bars; the pressure is a function of a compromise between the speed of execution of the method and the risk of obtaining impact traces of the particles on the surface; for the decorating method the limit between the exposed regions and the coating is better defined when the air supply pressure is lower; below a certain threshold the abrasive loses efficacy;
the flow of abrasive is oriented in relation to the surface of the article by an angle of between 60 and 90°, preferably between 75 and 90°; it is ascertained that when the flow is tilted in relation to the surface the coating is indeed stripped, but with an abrasive formed of starch in vitrified form traces of starch may subsist on the surface of the article, which requires cleaning before continuing the operations; for the decorating method the limit between the exposed regions and coated regions is more clean-cut when the attack by the abrasive flow is truly perpendicular to the surface; in addition the shape of the exposed region better corresponds to the opening geometry of the mask;
a nozzle outlet for the flow of particles is positioned at a distance from the surface of the article of between 20 and 250 mm, preferably between 80 and 120 mm;
if the abrasive is starch in vitrified form, the particle size of the abrasive is such that 90% of the particles have a size of between 200 and 850 μm; particles that are too fine do not have sufficient energy to abrade the coating, whilst larger particles risk producing impacts on the glass surface; for the decorating method the large particles generate coating edges that are less well defined;
the flow of abrasive has an intensity of between 25 and 300 kg/m²/s at the outlet of the nozzle; with this intensity range it is possible to obtain satisfactory results.

A further subject of the invention is a facility for treating a hollow glass article comprising means for grasping the article, characterized in that it comprises means for feeding an abrasive in the form of solid particles and means for spraying a flow of said abrasive against the glass article, the feed means comprising a system to recover the abrasive after spraying for recycling within the method, the recovery system comprising a filtering device to remove the coarsest and finest particles, the feed system comprising a dispensing device to supply new abrasive to compensate for material eliminated by the filtering device. The abrasive can then be used several times, which limits the generating of waste by the method. The finest particles originate from fragmentation of the particles in the flow of abrasive at the time of impacting the surface of the article and tooling. They no longer have any efficacy and their regular replacement can preserve the efficacy of the stock of abrasive. Also, the large elements for the main part do not correspond to particles originally present and are essentially removed fragments of coating. It is therefore useful for these to be removed. By adding material to offset discarded material, the quality of the stock of abrasive is permanently and continuously stabilized which avoids or limits stoppages for complete replacement of the abrasive.

According to one constructive provision, the recovery system comprises scales to weigh the material removed by the filtering device, the dispensing device being driven as a function also of the data provided by the scales. The overall weight of the abrasive in circulation within the facility is continually maintained substantially constant.

According to one improvement, the facility of the invention further comprises a work station to dedust the article. The article is likely to retain particle dust. It may therefore prove to be useful to remove this dust before continuing operations on the production line. Dedusting may also concern the tooling e.g. the grasping means and the masks. This operation can be performed by brushing and/or blowing compressed air.

According to one constructive provision, the spray means comprise at least one nozzle and allow relative movement of the nozzle and of the article during the spraying operation of the abrasive. The nozzle may be driven by translational and rotational movements so that the flow of material is properly guided in relation to the surface of the article, in particular in terms of direction and in terms of distance. However the movement may be imparted to the article. It may also be combination of movements of the nozzle and article. For example, the article may be driven about an axis of revolution whilst the nozzle moves parallel to this axis to run along the full length of the article.

### BRIEF DESCRIPTION OF THE FIGURES

The invention will be better understood and other particular aspects and advantages will become apparent on reading the following description which refers to the appended drawings among which:

FIG. 1 is a schematic view of a facility for treating glass articles according to the invention;

FIGS. 2 to 6 are schematic views illustrating the successive steps of the treatment method according to a first embodiment of the invention;

FIG. 7 is a similar view to FIG. 4 in a second embodiment of the method of the invention,

FIG. 8 is cross-section of an article in the progress of being treated.

### DETAILED DESCRIPTION

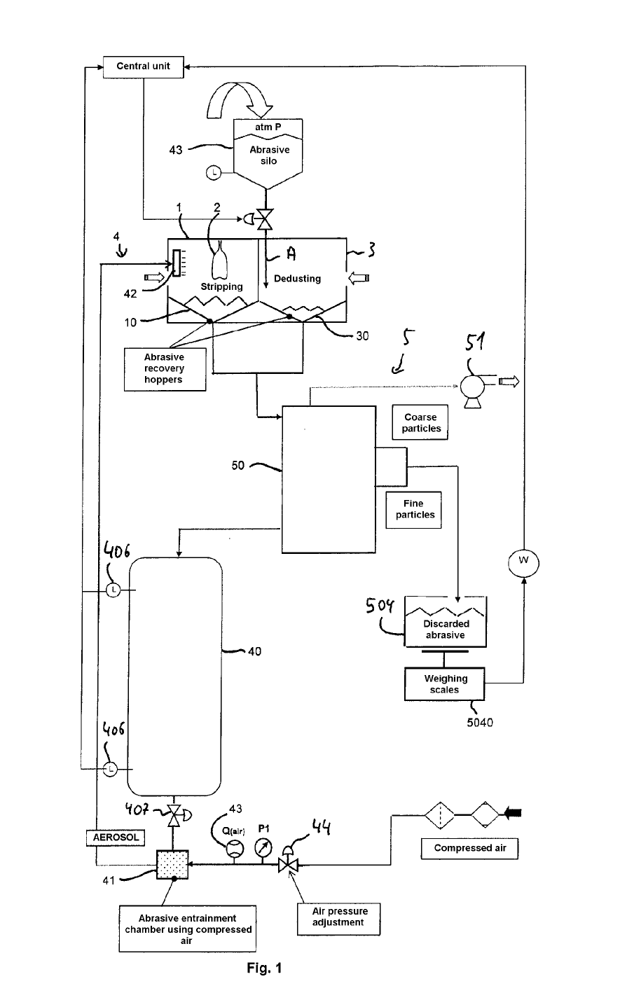

A facility allowing the implementation of the method of the invention for treating hollow glass articles is shown in FIG. 1. Said facility comprises several work stations placed side by side and through which the glass articles successively follow one after another. Among these stations the facility comprises a stripping station 1 at which abrasive in the form of solid particles is sprayed against the article 2 which is positioned at the stripping station 1. The stripping station 1 comprises a hopper 10 to collect the abrasive after spraying. The stripping station 1 is followed by a dedusting station 3 at which the article 2 arrives after passing through the stripping station 1. The dedusting station 3 also comprises a hopper 30 to recover the remainder of the abrasive particles detached from the glass article 2 by the dedusting operation. The facility further comprises feed means 4 to feed abrasive to the stripping station 1 and a recovery system 5 to recycle the abrasive after the spraying thereof. The recovery system 5 particularly comprises hoppers 10, 30 of the stations 1, 3. A description of the cycle of the abrasive will now be given starting from the stripping system 1.

The recovery system 5 further comprises a filtering system 50 towards which the abrasive recovered at the stripping and dedusting stations is transferred. The abrasive is then transferred to the feed means 4 and in particular towards a storage system 40. It is subsequently again sent to the stripping station 1. The dust thus collected is sent to a reservoir of discarded material 504 where it is weighed by scales 5040. An extraction unit 51 also allows a vacuum to be set up at the stations and thereby prevent the diffusion of dust within the workshop. It also allows the abrasive to be carried towards the filtering system 50.

The filtering system retains the coarsest particles which are continuously sent towards a reservoir of discarded material 504. It also retains the finest particles which are also sent towards the discarded material reservoir 504. The retained abrasive of intermediate particle size between the finest and coarsest particles is sent to the storage system 40.

The feed means 4 comprise the storage system 40 and an entrainment chamber 41 in which the abrasive is mixed with compressed air for conveying towards spraying means 42 at the stripping station 1. The supply of compressed air to the chamber comprises an adjustment valve 44 and flow meter 43 to adjust the flow rate of compressed air reproducibly. The storage system is connected to the entrainment chamber 41 by a metering valve 407 which adjusts the flow of abrasive transferred to the chamber 41. Said valve is of [symbol] [symbol] Accuflow [symbol] ™ type for example, sold by [symbol] [symbol] Pauli Systems Inc. [symbol] [symbol] .

The feed means 4 further comprise a dispensing device 43 to feed new abrasive A to compensate for the material removed by the filtering device. This dispensing device 43 comprises a silo equipped with a controlled valve and which discharges new abrasive into the hopper 30 of the dedusting station 3. The dose of abrasive A is controlled as a function of the weight of discarded material determined by the scales 5040 as and when material is discarded. A level detection system 406 in the storage system 40 also prevents abrasive excesses or shortages.

The spray means comprise at least one nozzle 42 and allow relative movement of the nozzle and article 2 during the abrasive spraying operation in manner known to persons skilled in the art.

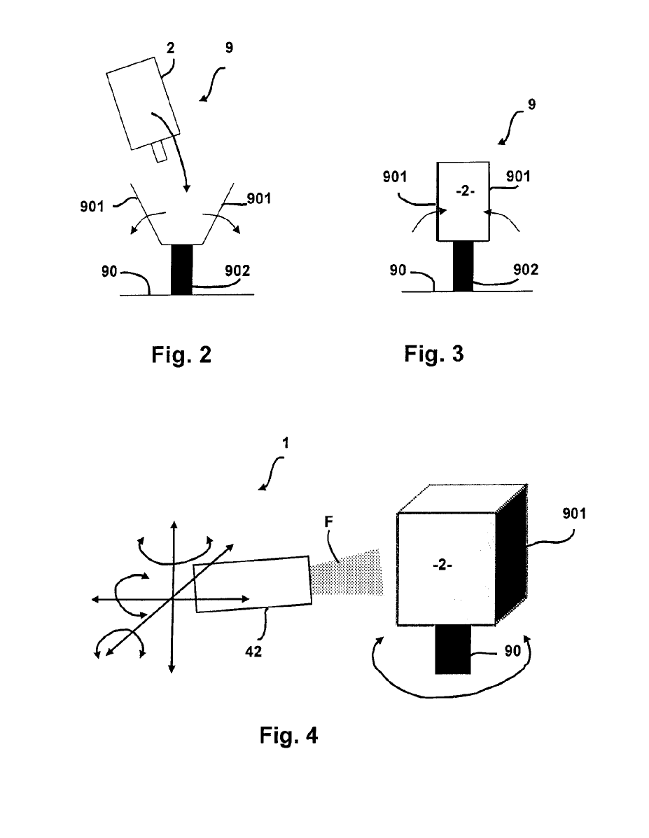

In one first embodiment of the facility with reference to FIGS. 2 to 6, a loading station 9 is provided upstream of the stripping station 1. As shown in FIG. 2, the loading station 9 comprises means for grasping the article 2 in the form of pincers 90 to take hold of the glass article 2 e.g. a bottle, each jaw of the pincers 90 being a mask 901 in metal surrounding the shape of the glass article 2. The pincers also comprise means 902 for closing the bottle 2 to protect the inside thereof against the entry of abrasive particles. The masks 901 are interchangeable so as to adapt the facility to the treatment of different models of the article 2. The grasping means 90 are designed to move towards the stripping station 1 once the article 2 is held by closing of the pincers 90 as shown in FIG. 3 so as to position the article 2 in front of the spray means 42.

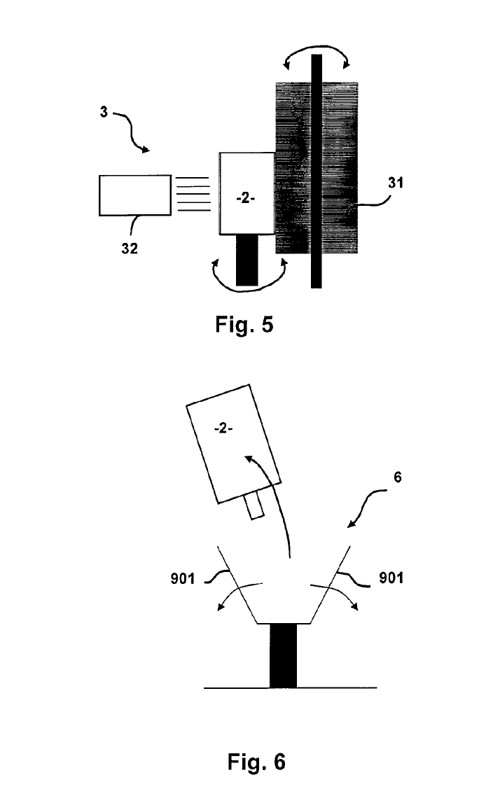

The pincers 90 are driven in rotation in front of the spray means 42 whilst these means are gently moved to obtain complete scanning of the surface to be treated as shown in FIG. 4. Each mask 901 comprises openings 9010 through which the flow of particles passes to reach the surface of the glass article 2. A space may also be provided between the masks 901, this space fulfilling the same role as an opening 9010. The nozzle 42 may be driven in translational movements along one, two or three axes of movement. It may also be driven in rotational movements along one, two or three axes. The choice of the number of axes of movement depends on the shape of the article 2, on form of the flow F of abrasive and on the distribution of the openings 9010. Once all the openings 9010 have been treated, the flow of abrasive is stopped and the pincers 90 are moved towards the dedusting station 3 at which the glass article 2 is cleaned by brushes 31 and/or by compressed air blowers 32 as shown in FIG. 5. After passing through the dedusting station 3 the pincers 90 are opened and the article 2 is unloaded at an unloading station 6 as shown in FIG. 6. The pincers 90 can then re-start a cycle.

Typically the facility is configured in the form of a turn-table in which the stations 9, 1, 3, 6 are arranged around a circle. One of the stations 9 is the loading point of the pincers 90 with the articles 2, the last station being the unloading point 7. The articles 2 are transferred step by step from one station to the next. However it can be envisaged that transfer takes place at constant, continuous speed. Configurations other than a turn-table are also possible e.g. a closed line arrangement. The loading and unloading can be manual or automated.

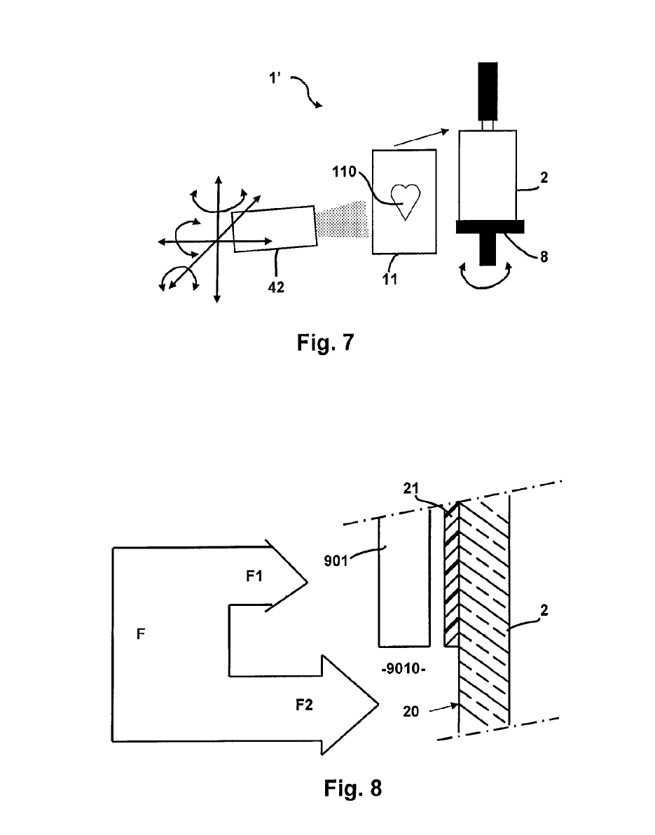

In a second embodiment, the articles 2 are placed on a conveyor 8 by which they are moved and supported between the different stations. Movement is discontinuous i.e. the articles 2 are moved step by step as far as the position at which they are treated. At the stripping station 1′ as shown in FIG. 7, the masks 11 are moved to face the article 2, and the flow F of abrasive is then sprayed through the openings 110 of the masks 11. The other operations are similar to those of the first embodiment with the exception of the fact that unloading of the conveyor 8 may not be necessary.

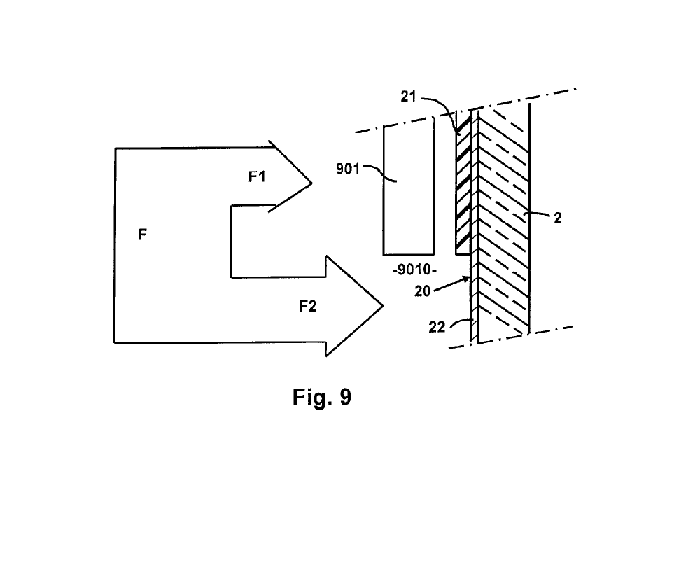

FIG. 8 shows an article 2 in the progress of being treated according to the method of the invention. The surface 20 of the article 2 has a coating 21 that was applied at a preceding step. A metal mask 901 comprising an opening 9010 is placed in front of the surface 20. A flow F of abrasive is sent substantially perpendicular to the surface 20. Part F1 of the flow is blocked by the mask 901 whilst the other part F2 of the flow reaches the surface 20 and exposes the glass.

In the variant shown in FIG. 9, the article comprises an underlying coating 22 on which a first coating 21 is applied. The underlying coating 22 has greater hardness than the first coating 21. When the article is treated, the first coating 21 is preserved behind the mask 901 but is stripped where it faces the opening 9010 so as to reveal the underlying coating 22.

In a third embodiment, not illustrated, the grasping means do not comprise a mask and the entirety of the outer surface of the article is treated, so as fully to strip off the coating.

Different articles in glass were treated following the method of the invention. In these examples, a glass article was placed at a stripping station. Abrasive was sprayed against coated surfaces of the article using either manual movement of the nozzle or rotational movement about a vertical axis imparted to the glass articles, the nozzle remaining fixed. The results observed are given below.

### Example 1

The glass article was a cylindrical bottle whose original surface was smooth. It was coated over its entire outer surface with a single layer of an acrylic, colorless, frosted dry varnish, water-dilutable, having a thickness of between 15 and 25 μm. The abrasive used was formed of particles of vitrified starch sold under the trade name [symbol] [symbol] ENVIROSTRIP XL [symbol] [symbol] by ADM. The nozzle used had an outlet cross-section of 10×100 mm. A mask was placed on tooling setting the bottle in rotation about its axis of revolution. The mask was placed against the article and hence set in movement with the article. The nozzle was fixed at 80 mm away from the surface of the article and sent a flow of abrasive perpendicular to the surface of the article.

The flow of abrasive was sent at an air pressure of 2 bars fed to the nozzle. The opening of the metering valve was small (about one quarter open). A region of about 110 cm² was stripped in 5 seconds. It is estimated that the flow of abrasive leaving the nozzle was 40 kg/m²/s and an amount of 18 kg/m² of abrasive must be sprayed.

Results: the stripped regions appeared transparent and formed windows, whilst the non-stripped regions had a frosted finish. The appearance of the regions was satisfactory. The separation between the regions was not perceptible to the touch.

### Example 2

This test differed from the preceding test in that the article was a bottle of square cross-section, the nozzle was operated manually and the varnish was frosted and colored. The flow of abrasive was sent using an air pressure of 3 bars fed to the nozzle. The metering valve was set at medium opening i.e. one half. A region of about 128 cm² was stripped in 3.5 seconds. It is estimated that the flow of abrasive leaving the nozzle was 80 kg/m²/s and that 21 kg/m² of abrasive must be sprayed.

Results: these were similar to those for Example 1.

### Example 3

With this test it was sought to determine the effect of stripping the underlying layer. The glass article was a conical bottle with original smooth surface. It comprised a gold underlying layer. It was coated over its entire outer surface with a single layer of acrylic, black, opaque, frosted dry lacquer, water-dilutable, having a thickness of between 15 and 25 μm. The abrasive used was the same as previously. The nozzle used had a circular outlet cross-section of diameter 20 mm. A mask was placed against the article. The nozzle was operated manually at a distance of between 100 and 200 mm away from the surface of the article, and sent a flow of abrasive perpendicular to the surface of the article.

The flow of abrasive was sent at an air pressure of 2 bars fed to the nozzle. The opening of the metering valve was small (about one quarter open). It is estimated that the flow of abrasive on leaving the nozzle was 125 kg/m²/s.

Results: the underlying gold layer was exposed and was not deteriorated.

### Example 4

This example differs from Example 3 in that the bottle was cylindrical, the underlying coating was enamel and the coating was formed of two layers: an acrylic, blue, opaque shiny dry lacquer, water-dilutable, and a colorless varnish of same type for a total thickness of 30 to 50 μm. The air pressure was 2.5 bars and the metering valve was set at half-open. It is estimated that the flow of abrasive on leaving the nozzle was 250 kg/m²/s.

Results: the underlying enamel coating was exposed and was not deteriorated.

### Example 5

The glass article was a conical bottle with original smooth surface. It comprised an underlying coating applied by serigraphy with an ultraviolet polymerizable ink. It was coated on its entire outer surface with a first layer of an acrylic, black, frosted dry lacquer, water-dilutable, and with a second layer in a colorless pearl varnish of same type for a total thickness of between 30 and 50 μm. The abrasive used was the same as previously. The nozzle used had an outlet cross-section of 10×100 mm. The nozzle was fixed at 100 mm away from the surface of the article which was set in rotation about its axis of revolution. The nozzle sent a flow of abrasive perpendicular to the surface of the article.

The flow of abrasive was sent at an air pressure of 2.5 bars fed to the nozzle. The metering valve was set at half-open. It is estimated that the flow of abrasive leaving the nozzle was 80 kg/m²/s.

Results: the underlying ink coating was exposed and was not deteriorated.

### Example 6

The glass article was a cylindrical bottle with original smooth surface having been subjected to heat treatment. It comprised a coating applied by serigraphy using ink polymerizable by heat and by ultraviolet radiation in three layers for a total thickness of between 10 and 20 μm. The abrasive used was the same as previously. The nozzle used had an outlet cross-section of 10×100 mm. The nozzle was fixed at 100 mm away from the surface of the article which was set in rotation about its axis of revolution. The nozzle sent a flow of abrasive perpendicular to the surface of the article.

The flow of abrasive was sent at an air pressure of 3 bars fed to the nozzle. The metering valve was set at half-open. A region of about 265 cm² was stripped in 45 seconds. It is estimated that the flow of abrasive leaving the nozzle was 80 kg/m²/s and 132 kg/m² of abrasive must be sprayed to obtain stripping.

Results: the stripped surface of the article was not deteriorated. Surface analysis showed that the heat treatment had been entirely preserved. A new decorative pattern was applied by serigraphy without any problem regarding quality in particular regarding the adhesion of the new decoration.

### Example 7

The glass article was a conical bottle with original smooth surface. It was coated over its entire outer surface with a single layer of an acrylic, colorless, dry varnish, water-dilutable, having a thickness of between 15 and 25 μm. The abrasive used was composed of particles of crushed nut shells. The nozzle used had an outlet cross-section of 10×100 mm. The nozzle was fixed at 100 mm away from the surface of the article which was set in rotation about its axis of revolution. The nozzle sent a flow of abrasive perpendicular to the surface of the article.

The flow of abrasive was sent at an air pressure of 2 bars fed to the nozzle. The metering valve was set at half-open. A region of about 235 cm² was stripped in 5 seconds. It is estimated that the flow of abrasive leaving the nozzle was 80 kg/m²/s and that 17 kg/m² of abrasive must be sprayed to obtain stripping.

Results: the surface of the article was stripped without being deteriorated.

The invention is not limited to the embodiments presented solely as examples. The nozzle can be operated manually or in fully automated manner.

1. A method for treating a hollow glass article comprising a coating, wherein a flow of abrasive is sprayed in the form of solid organic particles against the article to remove the coating at least in part.

2. The treatment method according to claim 1, wherein the abrasive is of plant origin.

3. The treatment method according to claim 2, wherein the abrasive is formed of a material comprising at least one of a polysaccharide, starch in vitrified form, and crushed nut shells.

4. The treatment method according to claim 1, wherein the coating of the article is organic.

5. The method according to claim 1, wherein the glass article comprises a coating underlying the first coating and of greater hardness, wherein the first coating is removed at least in part to expose the underlying coating.

6. A method for decorating a glass article wherein a coating is applied to the article, wherein treatment is performed according to the method of claim 1, a mask being inserted between the article and the flow of abrasive so as to preserve the coating behind the mask and remove the coating elsewhere.

7. The decorating method according to claim 6, wherein the glass article comprises frosted surfaces before the application of a colored coating onto at least one portion of said surfaces, the coating then being removed from at least one portion of the frosted surfaces.

8. The decorating method according to claim 6, wherein the glass article has a smooth surface and the coating has a frosted appearance.

9. A method for cleaning a glass article wherein the article comprises a coating and the entirety of the coating is removed using the method according to claim 1.

10. The method according to claim 1, wherein a nozzle for spraying abrasive is fed at a pressure of between 1.5 and 3.5 bars.

11. The method according to claim 1, wherein the flow of abrasive is oriented relative to the surface of the article at an angle of between 60 and 90°.

12. The method according to claim 1, wherein a nozzle outlet for the flow of abrasive is positioned at a distance from the surface of the article of between 20 and 250 mm.

13. The method according to claim 3, wherein, the abrasive is starch in vitrified form, the particle size of the abrasive is such that 90% of the particles have a size of between 200 and 850 μm.

14. The method according to claim 1, wherein the flow of abrasive has an intensity of between 25 and 250 kg/m²/s on leaving the nozzle.

15. A facility for treating a glass article comprising grasping means to grasp the article, means for feeding abrasive in the form of solid particles and means for spraying a flow of said particles against the glass article, the feed means comprising a system for recovering the abrasive after spraying, the recovery system comprising a filtering device to remove the coarsest and finest particles, the feed system comprising a dispensing device to supply new abrasive to compensate for the material removed by the filtering device.

16. The facility according to claim 15, wherein the recovery system comprises scales to weigh the material removed by the filtering device, the dispensing device being driven also as a function of the data provided by the scales.

17. The facility according to claim 15, further comprising a dedusting station to dedust the article and the tooling.

18. The facility according to claim 15, wherein the spray means comprise at least one nozzle and allow relative movement of the nozzle and of the article during the spraying operation of abrasive.
